(19) United States
(12) Patent Application Publication
(10) Pub. No.: US 2002/0175998 A1
(43) Pub. Date: Nov. 28, 2002

(54) Data-on-demand digital broadcast system utilizing prefetch data transmission

(76) Inventor: Khoi Nhu Hoang, Pleasanton, CA (US)

Correspondence Address: OPPENHEIMER WOLFF & DONNELLY, P. O. BOX 10356, PALO ALTO, CA, 94303, US

(21) Appl. No.: 10/054,008

(22) Filed: Oct. 19, 2001

Related U.S. Application Data
(63) Continuation-in-part of application No. 09/892,017, filed on Jun. 25, 2001.
Application No. 09/892,017 is a continuation-in-part of application No. 09/584,832, filed on May 31, 2000.

(51) Int. Cl. H04N 7/16

(52) U.S. Cl. 348/148; 725/146

(57) ABSTRACT

A method and system for a decreased idle time scheduling matrix for a data file reduced into data blocks. A scheduling matrix is generated and idle time is filled with data blocks that appear later in the matrix, keeping with the original sequence of data blocks. This is then repeated, or equally a new decreased idle time scheduling matrix is created. A preloading stream can be configured from the decreased time scheduling matrix. Specially designed set-top boxes are then described which can received these data blocks. In a preferred embodiment the set-top box can store a continuously broadcast and optimized preloading stream for increased bandwidth savings.

### CROSS-REFERENCE TO RELATED APPLICATIONS

The present application claims priority as a continuation in part to Khoi Hoang's co-pending application DECREASED IDLE TIME AND CONSTANT BANDWIDTH DATA-ON-DEMAND BROADCAST DELIVERY MATRICES filed Jun. 25, 2001, bearing U.S. patent application Ser. No. 09/892,017, which is a continuation-in-part application of Khoi Hoang's parent application entitled SYSTEMS AND METHODS FOR PROVIDING VIDEO-ON-DEMAND SERVICES FOR BROADCASTING SYSTEMS filed May 31, 2000, bearing U.S. patent application Ser. No. 09/584,832, which is incorporated herein by reference. The present application further claims priority to Khoi Nhu Hoang's co-pending patent application entitled UNIVERSAL DIGITAL BROADCAST SYSTEM AND METHODS filed on Apr. 24, 2001, bearing U.S. patent application Ser. No. 09/841,792, which is also incorporated herein by reference.

### BACKGROUND OF THE INVENTION

Video-on-demand (VOD) systems are one type of data-on-demand (DOD) system. In VOD systems, video data files are provided by a server or a network of servers to one or more clients on a demand basis. These systems will be well understood by those of skill in the art.

In a conventional VOD architecture, a server or a network of servers communicates with clients in a standard hierarchical client-server model. For example, a client sends a request to a server for a data file (e.g., a video data file). In response to the client request, the server sends the requested file to the client. In the standard client-server model, a client's request for a data file can be fulfilled by one or more servers. The client may have the capability to store any received data file locally in non-volatile memory for later use. The standard client-server model requires a two-way communications infrastructure. Currently, two-way communications requires building new infrastructure because existing cables can only provide one-way communications. Examples of two-way communications infrastructure are hybrid fiber optics coaxial cables (HFC) or all fiber infrastructure. Replacing existing cables is very costly and the resulting services may not be affordable to most users.

In addition, the standard client-server model has many limitations when a service provider (e.g., a cable company) attempts to provide VOD services to a large number of clients. One limitation of the standard client-server model is that the service provider has to implement a mechanism to continuously listen and fulfill every request from each client within the network; thus, the number of clients who can receive service is dependent on the capacity of such a mechanism. One mechanism uses massively-parallel computers having large and fast disk arrays as local servers. However, even the fastest existing local server can only deliver video data streams to about 1000 to 2000 clients at one time. Thus, in order to service more clients, the number of local servers must increase. Increasing local servers requires more upper level servers to maintain control of the local servers.

Another limitation of conventional systems is that a receiving set top box (STB) must download at least a portion of a selected VOD service before it can play the service. The delay required to download sufficient data in order to play a selected VOD can be significant even with very high download speeds.

Another limitation of the standard client-server model is that each client requires its own bandwidth. Thus, the total required bandwidth is directly proportional to the number of subscribing clients. Cache memory within local servers has been used to improve bandwidth limitation but using cache memory does not solve the problem because cache memory is also limited.

Presently, in order to make video-on-demand services more affordable for clients, existing service providers are increasing the ratio of clients per local server above the local server's capabilities. Typically, a local server, which is capable of providing service to 1000 clients, is actually committed to service 10,000 clients. This technique may work if most of the subscribing clients do not order videos at the same time. However, this technique is set up for failure because most clients are likely to want to view videos at the same time (i.e., evenings and weekends), thus, causing the local server to become overloaded.

Thus, it is desirable to provide a system that is capable of providing on-demand services without significant delay to a large number of clients over virtually any transmission medium without replacing existing infrastructure.

### SUMMARY OF THE INVENTION

The present invention teaches systems and methods for providing data-on-demand (DOD) services with reduced access time over existing DOD systems. The present invention also teaches systems and methods for providing DOD services over a decreased bandwidth.

In an exemplary embodiment, at a server side, a method for sending data to a client to provide data-on-demand services comprising the steps of: providing a decreased idle time linear sequence of data blocks containing data including a selected DOD service; removing a most frequently occurring data block from said decreased idle time sequence of data blocks; placing said removed most frequently occurring data block in a prefetch data stream such that said prefetch data stream includes prefetch data blocks corresponding to said selected DOD service; transmitting said prefetch data stream via said transmission medium; and transmitting said remaining decreased idle time sequence of data blocks via said transmission medium such that a receiving device may combine said remaining decreased idle time sequence of data blocks and said prefetch data blocks to create said selected DOD service, thereby decreasing the bandwidth necessary to transmit said DOD service. The DOD broadcast server method may further comprise: removing a plurality of additional data blocks from said decreased idle time sequence of data blocks; placing at least one of said plurality of additional data blocks in said prefetch data stream such that said prefetch data stream includes said most frequently occurring data blocks and said additional data blocks corresponding to said selected DOD service; and transmitting said remaining decreased idle time sequence of data blocks via said transmission medium such that a receiving device may combine said remaining decreased idle time sequence of data blocks, and said prefetch data blocks to create said selected DOD service, thereby further decreasing the bandwidth necessary to transmit said DOD service.

In an exemplary embodiment, at a client side, a method for processing data received from a server to provide data-on-demand services comprises the steps of: receiving a prefetch data stream containing prefetch data blocks corresponding to a selected DOD service; storing said prefetch data blocks in a memory location; receiving a primary data stream containing primary data blocks corresponding to said selected DOD service; and processing said primary data blocks and said prefetch data bocks in order to enable a user to access said selected DOD service. The method may further include: receiving user input indicative of said selected DOD service; switching to a channel corresponding to said selected DOD service in response to said user input; and receiving said primary data stream from said channel corresponding to said selected DOD service. In one embodiment, the method for processing data received from a server is performed by a set-top box at the client side.

A data-on-demand system comprises a first set of channel servers, a central controlling server for controlling the first set of channel servers, a first set of up-converters coupled to the first set of channel servers, a combiner/amplifier coupled to the first set of up-converters, and a combiner/amplifier adapted to transmit data via a transmission medium. In an exemplary embodiment, the data-on-demand system further comprises a channel monitoring module for monitoring the system, a switch matrix, a second set of channel servers, and a second set of up-converters. The channel monitoring module is configured to report to the central controlling server when system failure occurs. The central controlling server, in response to a report from the channel monitoring module, instructs the switch matrix to replace a defective channel server in the first set of channel servers with a channel server in the second set of channel servers and a defective up-converter in the first set of up-converters with an up-converter in the second set of up-converters.

Another embodiment of the present invention teaches a universal STB capable of receiving and handling a plurality of digital services such as VOD and digital broadcast. This embodiment teaches a universal STB having a highly flexible architecture capable of sophisticated processing of received data. This architecture includes a databus, a first communication device suitable for coupling to a digital broadcast communications medium, a memory typically including persistent and transient memory bi-directionally coupled to the databus, a digital data decoder bi-directionally coupled to the databus, and a central processing unit (CPU) bi-directionally coupled to the databus. The CPU of this embodiment of the present invention implements a STB control process for controlling the memory, the digital decoder, and the demodulator. The STB control process is operable to process digital data such as that received at the first communications device. The STB control process should be capable of receiving data blocks derived from a decreased idle time scheduling matrix as well as parallel streaming of such data blocks.

In another embodiment, the complex STB architectures allow a data-block optimized pre-loading data stream to be broadcast and loaded into an idle STB. The pre-loading of specific data blocks into a STB allows bandwidth savings at critical times. The pre-loading data stream (or “pre-fetch”) can be programmed to pre-deliver different data sequences at different times of the day based on VOD preferences.

### BRIEF DESCRIPTION OF THE DRAWINGS

FIG. 1A illustrates an exemplary DOD system in accordance with an embodiment of the invention.

FIG. 1B illustrates an exemplary DOD system in accordance with another embodiment of the invention.

FIG. 2 illustrates an exemplary channel server in accordance with an embodiment of the invention.

FIG. 3 illustrates an exemplary set-top box in accordance with an embodiment of the invention.

FIG. 4 illustrates an exemplary process for generating a scheduling matrix in accordance with an embodiment of the invention.

FIG. 5 graphically illustrates an example of a scheduling matrix of a six data block file.

FIG. 6 graphically illustrates how the data blocks of the scheduling matrix in FIG. 5 are moved up until all idle time slots are filled.

FIG. 7 graphically illustrates a new decreased idle time scheduling matrix.

FIG. 8 depicts the addition of the decreased idle time embodiment.

FIG. 9 is a flow chart diagram illustrating how the decreased idle time embodiment is accomplished.

FIG. 10 is a flow chart diagram illustrating a process for scheduling DOD data blocks for transmission on a primary data stream and a prefetch data stream in accordance with one embodiment of the present invention

FIG. 11 is a flow chart diagram illustrating a process for scheduling DOD data blocks for transmission on a primary data stream and a prefetch data stream in accordance with an alternative embodiment of the present invention; and

FIG. 12 is a flow chart diagram illustrating a set-top-box pre-loading process in accordance with one embodiment of the present invention.

### DETAILED DESCRIPTION OF THE INVENTION

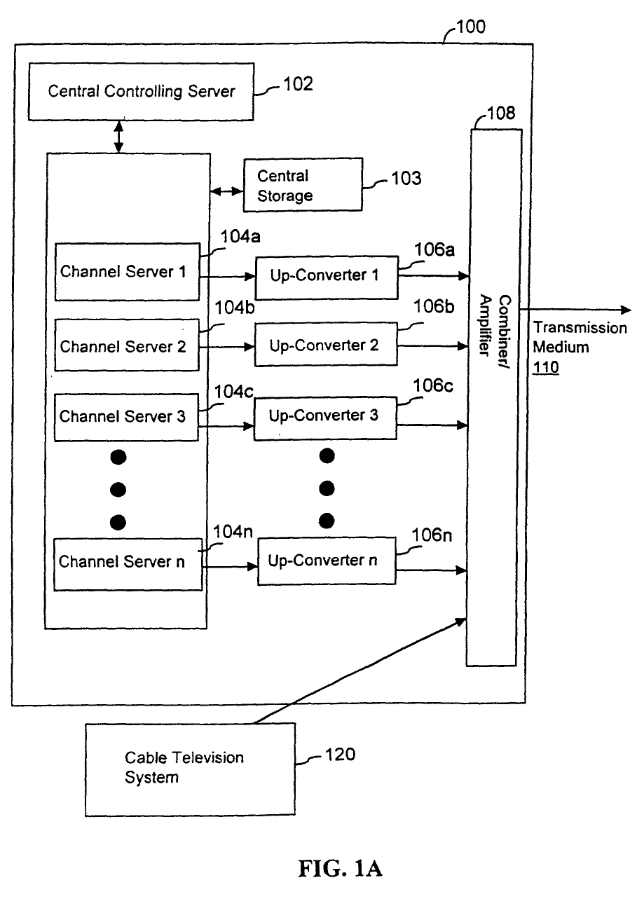

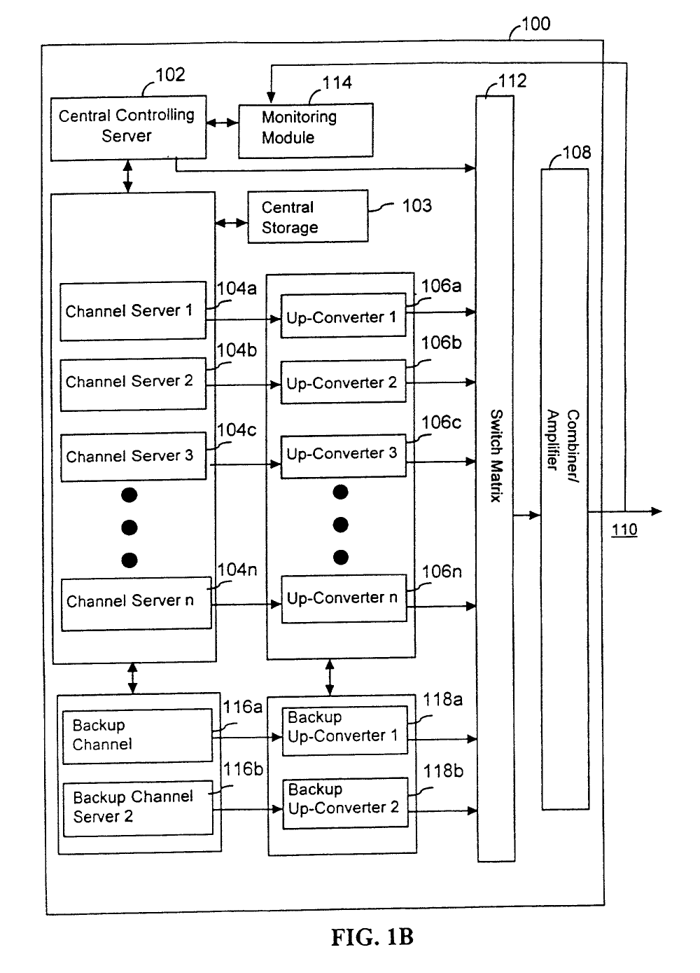

FIG. 1A illustrates an exemplary DOD system 100 in accordance with an embodiment of the invention. In this embodiment, the DOD system 100 provides data files, such as video files, on demand. However, the DOD system 100 is not limited to providing video files on demand but is also capable of providing other data files, for example, game files on demand. The DOD system 100 includes a central controlling server 102, a central storage 103, a plurality of channel servers 104a-104n, a plurality of up-converters 106a-106n, and a combiner/amplifier 108. The central controlling server 102 controls the channel servers 104. The central storage 103 stores data files in digital format. In an exemplary embodiment, data files stored in the central storage 103 are accessible via a standard network interface (e.g., Ethernet connection) by any authorized computer, such as the central controller server 102, connected to the network. Each channel server 104 is assigned to a channel and is coupled to an up-converter 106. The channel servers 104 provide data files that are retrieved from the central storage 103 in accordance with instructions from the central controlling server 102. The output of each channel server 104 is a quadrature amplitude modulation (QAM) modulated intermediate frequency (IF) signal having a suitable frequency for the corresponding up-converter 106. The QAM-modulated IF signals are dependent upon adopted standards. The current adopted standard in the United States is the data-over-cable-systems-interface-specification (DOCSIS) standard, which requires an approximately 43.75 MHz IF frequency. The up-converters 106 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz. The outputs of the up-converters 106 are applied to the combiner/amplifier 108. The combiner/amplifier 108 amplifies, conditions, and combines the received RF signals then outputs the signals out to a transmission medium 110.

In an exemplary embodiment, the central controlling server 102 includes a graphics user interface (not shown) to enable a service provider to schedule data delivery by a drag-and-drop operation. Further, the central controlling server 102 authenticates and controls the channel servers 104 to start or stop according to delivery matrices. In an exemplary embodiment, the central controlling server 102 automatically selects a channel and calculates delivery matrices for transmitting data files in the selected channel. The central controlling server 102 provides offline addition, deletion, and update of data file information (e.g., duration, category, rating, and/or brief description). Further, the central controlling server 102 controls the central storage 103 by updating data files and databases stored therein.

In an exemplary embodiment, an existing cable television system 120 may continue to feed signals into the combiner/amplifier 108 to provide non-DOD services to clients. Thus, the DOD system 100 in accordance with the invention does not disrupt present cable television services.

FIG. 1B illustrates another exemplary embodiment of the DOD system 100 in accordance with the invention. In addition to the elements illustrated in FIG. 1A, the DOD system 100 includes a switch matrix 112, a channel monitoring module 114, a set of back-up channel servers 116a-116b, and a set of back-up up-converters 118a-118b. In one embodiment, the switch matrix 112 is physically located between the up-converters 106 and the combiner/amplifier 108. The switch matrix 112 is controlled by the central controlling server 102. The channel monitoring module 114 comprises a plurality of configured set-top boxes, which simulate potential clients, for monitoring the health of the DOD system 100. Monitoring results are communicated by the channel monitoring module 114 to the central controlling server 102. In case of a channel failure (i.e., a channel server failure, an up-converter failure, or a communication link failure), the central controlling server 102 through the switch matrix 112 disengages the malfunctioning component and engages a healthy backup component 116 and/or 118 to resume service.

In an exemplary embodiment, data files being broadcasted from the DOD system 100 are contained in motion pictures expert group (MPEG) files. Each MPEG file is dynamically divided into data blocks and sub-blocks mapping to a particular portion of a data file along a time axis. These data blocks and sub-blocks are sent during a pre-determined time in accordance with three-dimensional delivery matrices provided by the central controlling server 102. A feedback channel is not necessary for the DOD system 100 to provide DOD services. However, if a feedback channel is available, the feedback channel can be used for other purposes, such as billing or providing Internet services.

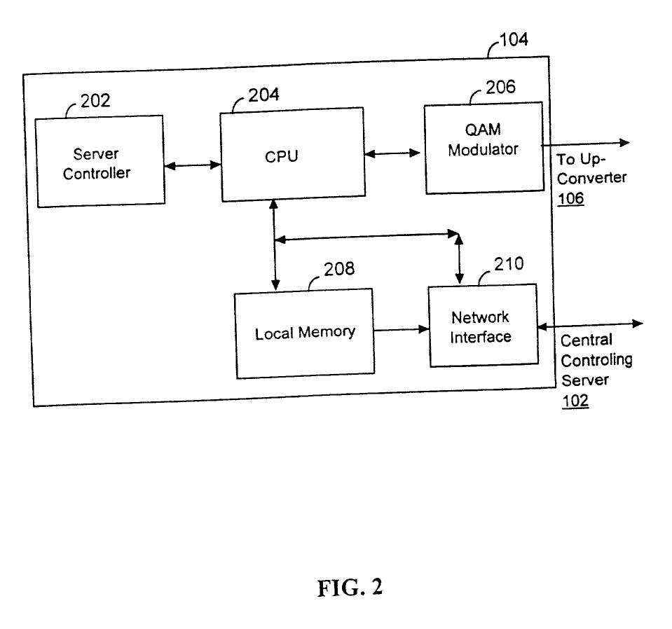

FIG. 2 illustrates an exemplary channel server 104 in accordance with an embodiment of the invention. The channel server 104 comprises a server controller 202, a CPU 204, a QAM modulator 206, a local memory 208, and a network interface 210. The server controller 202 controls the overall operation of the channel server 104 by instructing the CPU 204 to divide data files into blocks (further into sub-blocks and data packets), select data blocks for transmission in accordance with a delivery matrix provided by the central controlling server 102, encode selected data, compress encoded data, then deliver compressed data to the QAM modulator 206. The QAM modulator 206 receives data to be transmitted via a bus (i.e., PCI, CPU local bus) or Ethernet connections. In an exemplary embodiment, the QAM modulator 206 may include a downstream QAM modulator, an upstream quadrature amplitude modulation/quadrature phase shift keying (QAN/QPSK) burst demodulator with forward error correction decoder, and/or an upstream tuner. The output of the QAM modulator 206 is an IF signals that can be applied directly to an up-converter 106.

The network interface 210 connects the channel server 104 to other channel servers 104 and to the central controlling server 102 to execute the scheduling and controlling instructions from the central controlling server 102, reporting status back to the central controlling server 102, and receiving data files from the central storage 103. Any data file retrieved from the central storage 103 can be stored in the local memory 208 of the channel server 104 before the data file is processed in accordance with instructions from the server controller 202. In an exemplary embodiment, the channel server 104 may send one or more DOD data streams depending on the bandwidth of a cable channel (e.g., 6, 6.5, or 8 MHz), QAM modulation (e.g., QAM 64 or QAM 256, and a compression standard/bit rate of the DOD data stream (i.e., MPEG-1 or MPEG-2).

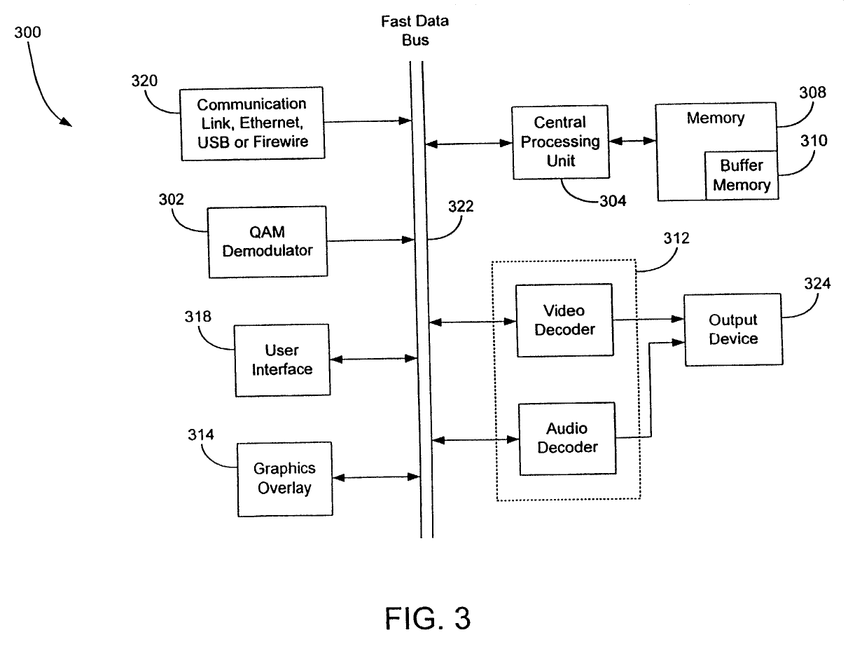

FIG. 3 illustrates a universal set-top box (STB) 300 in accordance with one embodiment of the invention. The STB 300 comprises a QAM demodulator 302, a CPU 304, a local memory 308, a buffer memory 310, a decoder 312 having video and audio decoding capabilities, a graphics overlay module 314, a user interface 318, a communications link 320, and a fast data bus 322 coupling these devices as illustrated. The CPU 302 controls overall operation of the universal STB 300 in order to select data in response to a client's request, decode selected data, decompress decoded data, re-assemble decoded data, store decoded data in the local memory 308 or the buffer memory 310, and deliver stored data to the decoder 312. In an exemplary embodiment, the local memory 308 comprises non-volatile memory (e.g., a hard drive) and the buffer memory 310 comprises volatile memory.

In one embodiment, the QAM demodulator 302 comprises transmitter and receiver modules and one or more of the following: privacy encryption/decryption module, forward error correction decoder/encoder, tuner control, downstream and upstream processors, CPU and memory interface circuits. The QAM demodulator 302 receives modulated IF signals, samples and demodulates the signals to restore data.

In an exemplary embodiment, when access is granted, the decoder 312 decodes at least one data block to transform the data block into images displayable on an output screen. The decoder 312 supports commands from a subscribing client, such as play, stop, pause, step, rewind, forward, etc. The decoder 312 provides decoded data to an output device 324 for use by the client. The output device 324 may be any suitable device such as a television, computer, any appropriate display monitor, a VCR, or the like.

The graphics overlay module 314 enhances displayed graphics quality by, for example, providing alpha blending or picture-in-picture capabilities. In an exemplary embodiment, the graphics overlay module 314 can be used for graphics acceleration during game playing mode, for example, when the service provider provides games-on-demand services using the system in accordance with the invention.

The user interface 318 enables user control of the STB 300, and may be any suitable device such as a remote control device, a keyboard, a smartcard, etc. The communications link 320 provides an additional communications connection. This may be coupled to another computer, or may be used to implement bi-directional communication. The data bus 322 is preferably a commercially available “fast” data bus suitable for performing data communications in a real time manner as required by the present invention. Suitable examples are USB, firewire, etc.

In an exemplary embodiment, although data files are broadcast to all cable television subscribers, only the DOD subscriber who has a compatible STB 300 will be able to decode and enjoy data-on-demand services. In one exemplary embodiment, permission to obtain data files on demand can be obtained via a smart card system in the user interface 318. A smart card may be rechargeable at a local store or vending machine set up by a service provider. In another exemplary embodiment, a flat fee system provides a subscriber unlimited access to all available data files.

In preferred embodiments, data-on-demand interactive features permits a client to select at any time an available data file. The amount of time between when a client presses a select button and the time the selected data file begins playing is referred to as a response time. As more resources are allocated (e.g., bandwidth, server capability) to provide DOD services, the response time gets shorter. In an exemplary embodiment, a response time can be determined based on an evaluation of resource allocation and desired quality of service. When combined with the embodiment of placing the first data block in a parallel stream, the response time becomes a factor only of the time it takes to receive and process that first data block.

In one embodiment, the number of data blocks (NUM_OF_BLKS) for each data file can be calculated as follows:

Estimated_BLK_Size=(DataFile Size*TS)/DataFile_Length (1)

BLK SIZE=(Estimated BLK Size+CLUSTER SIZE−1Byte)/CLUSTER_SIZE (2)

BLK_SIZE_BYTES=BLK_SIZE*CLUSTER_SIZE (3)

NUM_OF_BLKS=(DataFile_Size+BLK_SIZE_BYTES−1Byte)/BLK_SIZE_BYTES (4)

In equations (1) to (4), the Estimated_BLK_Size is an estimated block size (in Bytes); the DataFile_Size is the data file size (in Bytes); TS represents the duration of a time slot (in seconds); DataFile_Length is the duration of the data file (in seconds); BLK SIZE is the number of clusters needed for each data block; CLUSTER_SIZE is the size of a cluster in the local memory 208 for each channel server 104 (e.g., 64KBytes); BLK_SIZE_BYTES is a block size in Bytes. In this embodiment, the number of blocks (NUM_OF_BLKS) is equal to the data file size (in Bytes) plus a data block size in Bytes minus 1, Byte and divided by a data block size in Bytes. Equations (1) to (4) illustrate one specific embodiment. A person of skill in the art would recognize that other methods are available to calculate a number of data blocks for a data file. For example, dividing a data file into a number of data blocks is primarily a function of an estimated block size and the cluster size of the local memory 208 of a channel server 104. Thus, the invention should not be limited to the specific embodiment presented above.

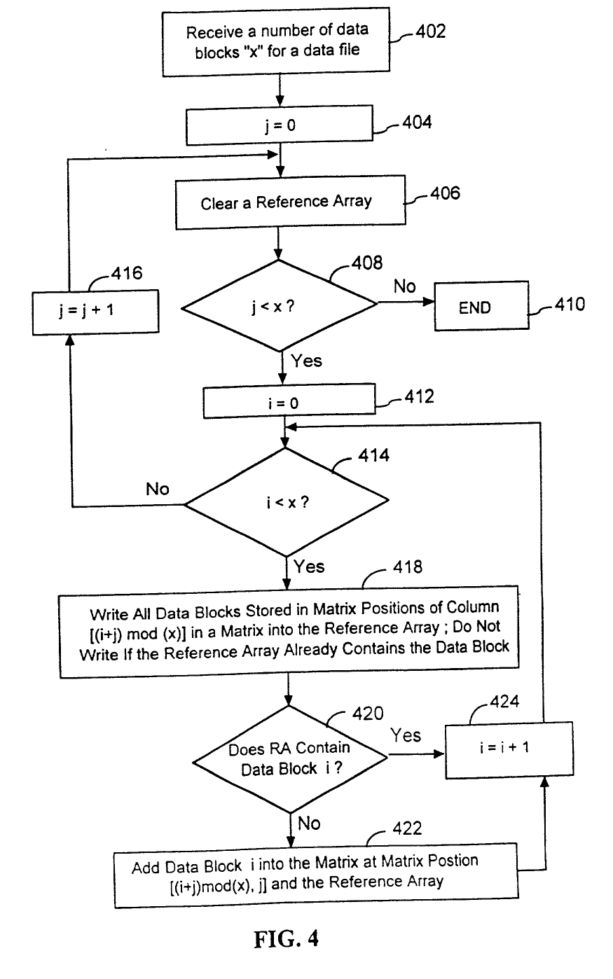

FIG. 4 illustrates an exemplary process for generating a scheduling matrix for sending a data file in accordance with an embodiment of the invention. In an exemplary embodiment, this invention uses time division multiplexing (TDM) and frequency division multiplexing (FDM) technology to compress and schedule data delivery at the server side. In an exemplary embodiment, a scheduling matrix is generated for each data file. In one embodiment, each data file is divided into a number of data blocks and the scheduling matrx is generated based on the number of data blocks. Typically, a scheduling matrix provides a send order for sending data blocks of a data file from a server to clients, such that the data blocks are accessible in sequential order by any client who wishes to access the data file at a random time.

At step 402, a number of data blocks (x) for a data file is received. A first variable, j, is set to zero (step 404). A reference array is cleared (step 406). The reference array keeps track of data blocks for internal management purposes. Next, j is compared to x (step 408). If j is less than x, a second variable, i, is set to zero (step 412). Next, i is compared to x (step 414). If i is less than x, data blocks stored in the column [(i+j) modulo (x)] of a scheduling matrix are written into the reference array (step 418). If the reference array already has such data block(s), do not write a duplicate copy. Initially, since the scheduling matrix does not yet have entries, this step can be skipped. Next, the reference array is checked if it contains data block i (step 420). Initially, since all entries in the reference array have been cleared at step 406, there would be nothing in the reference array. If the reference array does not contain data block i, data block i is added into the scheduling matrix at matrix position [(i+j) modulo (x), j] and the reference array (step 422). After the data block i is added to the scheduling matrix and the reference array, i is incremented by 1, such that i=i+1 (step 424), then the process repeats at step 414 until i=x. If the reference array contains data block i, i is incremented by 1, such that i=i+1 (step 424), then the process repeats at step 414 until i=x. When i=x, j is incremented by 1, such that j=j+1 (step 416) and the process repeats at step 406 until j=x. The entire process ends when j=x (step 410).

In an exemplary embodiment, if a data file is divided into six data blocks (x=6), the scheduling matrix and the reference arrays are as follows:

Scheduling Matrix (SM)

| TSO | TS1 | TS2 | TS3 | TS4 | TS5 |
|---|---|---|---|---|---|
| [0, 0] blk0 | [1, 0] blk1 | [2, 0] blk2 | [3, 0] blk3 | [4, 0] blk4 | [5, 0] blk5 |
| [0, 1] | [1, 1] blk0 | [2, 1] | [3, 1] | [4, 1] | [5, 1] |
| [0, 2] | [1, 2] | [2, 2] blk0 | [3, 2] blk1 | [4, 2] | [5, 2] |
| [0, 3] | [1, 3] | [2, 3] | [3, 3] blk0 | [4, 3] | [5, 3] blk2 |
| [0, 4] | [1, 4] blk3 | [2, 4] | [3, 4] | [4, 4] blk0 | [5, 5] blk1 |
| [0, 5] | [1, 5] | [2, 5] | [3, 5] blk4 | [4, 5] | [5, 5] blk0 |

Reference Array (RA)

| | space0 | space1 | space2 | space3 | space4 | space5 |
|---|---|---|---|---|---|---|
| TS0 | blk0 | blk1 | blk2 | blk3 | blk4 | blk5 |
| TS1 | blk1 | blk0 | blk2 | blk3 | blk4 | blk5 |
| TS2 | blk2 | blk0 | blk3 | blk1 | blk4 | blk5 |
| TS3 | blk3 | blk1 | blk0 | blk4 | blk5 | blk2 |
| TS4 | blk4 | blk0 | blk5 | blk2 | blk1 | blk3 |
| TS5 | blk5 | blk2 | blk1 | blk0 | blk3 | blk4 |

Appendix A attached to this application describes a step-by-step process of the exemplary process illustrated in FIG. 4 to generate the above scheduling matrix and reference arrays. In this exemplary embodiment, based on the scheduling matrix above, the six data blocks of the data file are sent in the following sequence:

TS0=>blk0

TSI=>blk0, blk1, blk3

TS2=>blk0, blk2

TS3=>blk0, blk1, blk3, blk4

TS4=>blk0, blk4

TS5=>blk0, blk1, blk2, blk5

In another exemplary embodiment, a look-ahead process can be used to calculate a look-ahead scheduling matrix to send a predetermined number of data blocks of a data file prior to a predicted access time. For example, if a predetermined look-ahead time is the duration of one time slot, for any time slot greater than or equal to time slot number four, data block 4 (blk4) of a data file should be received by a STB 300 at a subscribing client at or before TS3, but blk4 would not be played until TS4. The process steps for generating a look-ahead scheduling matrix is substantially similar to the process steps described above for FIG. 4 except that the look-ahead scheduling matrix in this embodiment schedules an earlier sending sequence based on a look-ahead time. Assuming a data file is divided into six data blocks, an exemplary sending sequence based on a look-ahead scheduling matrix, having a look-ahead time of the duration of two time slots, can be represented as follows:

TS0=>blk0

TS1=>blk0, blk1, blk3, blk4

TS2=>blk0, blk2

TS3=>blk0, blk1, blk3, blk4, blk5

TS4=>blk0, blk5

TS5=>blk0, blk1, blk2

A three-dimensional delivery matrix for sending a set of data files is generated based on the scheduling matrices for each data file of the set of data files. In the three-dimensional delivery matrix, a third dimension containing IDs for each data file in the set of data files is generated. The three-dimensional delivery matrix is calculated to efficiently utilize available bandwidth in each channel to deliver multiple data streams. In an exemplary embodiment, a convolution method, which is well known in the art, is used to generate a three-dimensional delivery matrix to schedule an efficient delivery of a set of data files. For example, a convolution method may include the following policies: (1) the total number of data blocks sent in the duration of any time slot (TS) should be kept at a smallest possible number; and (2) if multiple partial solutions are available with respect to policy (1), the preferred solution is the one which has a smallest sum of data blocks by adding the data blocks to be sent during the duration of any reference time slot, data blocks to be sent during the duration of a previous time slot (with respect to the reference time slot), and data blocks to be sent during the duration of a next time slot (with respect to the reference time slot). For example, assuming an exemplary system sending two short data files, M and N, where each data file is divided into six data blocks, the sending sequence based on a scheduling matrix is as follows:

TS0=>blk0

TS1=>blk0, blk1, blk3, blk4

TS2=>blk0, blk2

TS3=>blk0, blk1, blk3, blk4

TS4=>blk0, blk4

TS5=>blk0, blk1 ,blk2, blk5

Applying the exemplary convolution method as described above, possible combinations of delivery matrices are as follows:

| Option 1: Send video file N at shift 0 TS | Total Data Blocks |
|---|---|
| TS0 => M0, N0 | 2 |
| TS1 => M0, M1, M3, N0, N1, N3 | 6 |
| TS2 => M0, M2, N0, N2 | 4 |
| TS3 => M0, M1, M3, M4, N0, N1, N3, N4 | 8 |
| TS4 => M0, M4, N0, N4 | 4 |
| TS5 => M0, M1, M2, M5, N0, N1, N2, N5 | 8 |

| Option 2: Send video file N at shift 1 TS | Total Data Blocks |
|---|---|
| TS0 => M0, N0, N1, N3 | 4 |
| TS1 => M0, M1, M3, N0, N2 | 5 |
| TS2 => M0, M2, N0, N1, N3, N4 | 6 |
| TS3 => M0, M1, M3, M4, N0, N4 | 6 |
| TS4 => M0, M4, N0, N1, N2, N5 | 6 |
| TS5 => M0, M1, M2, M5, N0 | 5 |

| Option 3: Send video file N at shift 2 TS | Total Data Blocks |
|---|---|
| TS0 => M0, N0, N2 | 3 |
| TS1 => M0, M1, M3, N0, N1, N3, N4 | 7 |
| TS2 => M0, M2, N0, N4 | 4 |
| TS3 => M0, M1, M3, M4, N0, N1, N2, N5 | 8 |
| TS4 => M0, M4, N0 | 3 |
| TS5 => M0, M1, M2, M5, N0, N1, N3 | 7 |

| Option 4: Send video file N at shift 3 TS | Total Data Blocks |
|---|---|
| TS0 => M0, N0, N1, N3, N4 | 5 |
| TS1 => M0, M1, M3, N0, N4 | 5 |
| TS2 => M0, M2, N0, N1, N2, N5 | 6 |
| TS3 => M0, M1, M3, M4, N0 | 5 |
| TS4 => M0, M4, N0, N1, N3 | 5 |
| TS5 => M0, M1, M2, M5, N0, N1, N2 | 6 |

| Option 5: Send video file N at shift 4 TS | Total Data Blocks |
|---|---|
| TS0 => M0, N0, N4 | 3 |
| TS1 => M0, M1, M3, N0, N1, N2, N5 | 7 |
| TS2 => M0, M2, N0 | 3 |
| TS3 => M0, M1, M3, M4, N0, N1, N3 | 7 |
| TS4 => M0, M4, N0, N2 | 4 |
| TS5 => M0, M1, M2, MS, N0, N1, N3, N4 | 8 |

| Option 6: Send video file N at shift 5 TS | Total Data Blocks |
|---|---|
| TS0 => M0, N0, N1, N2, N5 | 5 |
| TS1 => M0, M1, M3, N0 | 4 |
| TS2 => M0, M2, N0, N1, N3 | 5 |
| TS3 => M0, M1, M3, M4, N0, N2 | 6 |
| TS4 => M0, M4, N0, N1, N3, N4 | 6 |
| TS5 => M0, M1, M2, M5, N0, N4 | 6 |

Applying policy (1), options 2, 4, and 6 have the smallest maximum number of data blocks (i.e., 6 data blocks) sent during any time slot. Applying policy (2), the optimal delivery matrix in this exemplary embodiment is option 4 because option 4 has the smallest sum of data blocks of any reference time slot plus data blocks of neighboring time slots (i.e., 16 data blocks). Thus, optimally for this embodiment, the sending sequence of the data file N should be shifted by three time slots. In an exemplary embodiment, a three-dimensional delivery matrix is generated for each channel server 104.

When data blocks for each data file are sent in accordance with a delivery matrix, a large number of subscribing clients can access the data file at a random time and the appropriate data blocks of the data file will be timely available to each subscribing client. In the example provided above, assume the duration of a time slot is equal to 5 seconds, the DOD system 100 sends data blocks for data files M and N in accordance with the optimal delivery matrix (i.e., shift delivery sequence of data file N by three time slots) in the following manner:

Time 00:00:00=>M0 N0 N1 N3 N4

Time 00:00:05=>M0 M1 M3 N0 N4

Time 00:00:10=>M0 M2 N0 N1 N2 N5

Time 00:00:15=>M0 M1 M3 M4 N0

Time 00:00:20=>M0 M4 N0 N1 N3

Time 00:00:25=>M0 M1 M2 M5 N0 N2

Time 00:00:30=>M0 N0 N1 N3 N4

Time 00:00:35=>M0 M1 M3 N0 N4

Time 00:00:40=>M0 M2 N0 N1 N2 N5

Time 00:00:45=>M0 M1 M3 M4 N0

Time 00:00:50=>M0 M4 N0 N1 N3

Time 00:00:55=>M0 M1 M2 M5 N0 N2

If at time 00:00:00 a client A selects movie M, the STB 300 at client A receives, stores, plays, and rejects data blocks as follows:

| | | |
|---|---|---|
| Time 00:00:00 => | Receive M0 => | play M0, store M0. |
| Time 00:00:05 => | Receive M1, M3 => | play M1, store M0, M1, M3. |
| Time 00:00:10 => | Receive M2 => | play M2, store M0, M1, M2, M3. |
| Time 00:00:15 => | Receive M4 => | play M3, store M0, M1, M2, M3, M4. |
| Time 00:00:20 => | Receive none => | play M4, store M0, M1, M2, M3, M4. |
| Time 00:00:25 => | Recv MS => | play M5, store M0, M1, M2, M3, M4, M5. |

If at time 00:00:10, a client B selects movie M, the STB 300 at client B receives, stores, plays, and rejects data blocks as follows:

| | | |
|---|---|---|
| Time 00:00:10 => | Rcv M0, M2 => | play M0, store M0, M2. |
| Time 00:00:15 => | Rcv M1, M3, M4 => | play M1, store M0, M1, M2, M3,M4. |
| Time 00:00:20 => | Rcv none => | play M2, store M0, M1, M2, M3, M4. |
| Time 00:00:25 => | Rcv M5 => | play M3, store M0, M1, M2, M3, M4, M5. |
| Time 00:00:30 => | Rcv none => | play M4, store M0, M1, M2, M3, M4, M5. |
| Time 00:00:35 => | Rcv none => | play M5, store M0, M1, M2, M3, M4, M5. |

If at time 00:00:15, a client C selects movie N, the STB 300 of the client C receives, stores, plays, and rejects data blocks as follows:

| | | |
|---|---|---|
| Time 00:00:15 => | Rcv N0 => | play N0, store N0. |
| Time 00:00:20 => | Rcv N1 N3 => | play N1, store N0, N1, N3. |
| Time 00:00:25 => | Rcv N2 => | play N2, store N0, N1, N2, N3. |
| Time 00:00:30 => | Rcv N4 => | play N3, store N0, N1, N2, N3, N4. |
| Time 00:00:35 => | Rcv none => | play N4, store N0, N1, N2, N3, N4. |
| Time 00:00:40 => | Rcv N5 => | play N5, store N0, N1, N2, N3, N4, N5. |

If at time 00:00:30, a client D also selects movie N, the STB 300 at the client D receives, stores, plays, and rejects data blocks as follows:

| | | |
|---|---|---|
| Time 00:00:30 => | Rcv N0, N1, N3, N4 => | play N0, store N0, N1, N3, N4. |
| Time 00:00:35 => | Rcv none => | play N1, store N0, N1, N3, N4. |
| Time 00:00:40 => | Rcv N2, N5 => | play N2, store N0, N1, N2, N3, N4, N5. |
| Time 00:00:45 => | Rcv none => | play N3, store N0, N1, N2, N3, N4, N5. |
| Time 00:00:50 => | Rcv none => | play N4, store N0, N1, N2, N3, N4, N5. |
| Time 00:00:55 => | Rcv none => | play N5, store N0, N1, N2, N3, N4, N5. |

As shown in the above examples, any combination of clients can at a random time independently select and begin playing any data file provided by the service provider. The above denotation of “Receive” is slightly misleading as the system is always receiving a continuous stream of data blocks determined by the time slot, but at any given point, the receiving STB may only require certain data blocks, having already received and stored the other received data blocks. This need is referred to as “receive” above, but may be more accurately referred to as “non rejected.” Therefore, “receive M4” could be termed “reject all but M4” and “receive none” could better be termed “reject all.”

What becomes apparent from the examples given above is that available bandwidth is not being fully used during certain time slots. In particular, during at least some time slots there is “idle time” wherein no transmission occurs. This idle time is an inherently ineffective use of available bandwidth. Let's take as an example option 4 shown above wherein two data blocks are transmitted during the respective time slot. In other words, in a time slot having bandwidth suitable for transmitting six data blocks, four data block transmission periods are left idle. Although this is not dramatic in option 4, it becomes more extreme as data files become thousands of data blocks big. Even using optimal combination protocols for combining data, there may still be significant sections of empty block space.

This empty block space equates to bandwidth which is not being used, and therefore is wasted bandwidth. A goal of this invention is to decrease as much idle time as possible, and therefore one embodiment of the current invention is to perform another step after the scheduling matrix is determined, referred to herein as a decreased idle time scheduling matrix.

An exemplary model of a decreased idle time scheduling matrixes can be explained with reference to the six block scheduling matrix described above, but repeated here for convenience. Idle time during which bandwidth could be utilized to transmit a data block is denoted “<-->” for clarity:

TS0=>blk0, <-->, <-->, <-->

TS1=>blk0, blk1, blk3, <-->

TS2=>blk0, blk2, <-->, <-->

TS3=>blk0, blk1, blk3, blk4

TS4=>blk0, blk4, <-->, <-->

TS5=>blk0, blk1, blk2, blk5

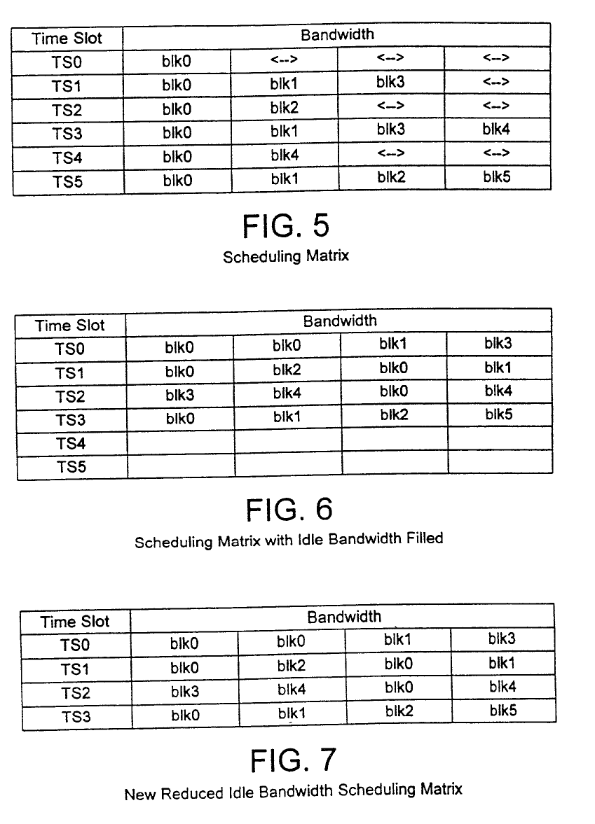

This is shown in graphical form in FIG. 5. The scheduling matrix clearly has unused bandwidth in the form of idle time during most time slots. The present invention teaches reduction of this idle time by utilizing constant bandwidth from time slot to time slot. The key to accomplishing decreased idle transmission time through constant bandwidth utilization is an understanding that the delivery sequence of the data blocks must be adhered to, while the exact time slot in which a data block is delivered is not relevant except that the data block must be received prior to or at the time in which it must be accessed. Accordingly, constant bandwidth utilization is accomplished by transmitting a constant number of data blocks within each time slot according to the delivery sequence set forth by the scheduling matrix and with disregard to the time slot assigned by the scheduling matrix.

In the six block scheduling matrix described above in detail, there is a significant amount of idle time in TS0, TS1, TS2 and TS4. For the sake of example, assume the desired constant bandwidth corresponds to transmission of four data blocks per time slot. Accordingly, the idle time is decreased by moving forward data blocks until four data blocks are scheduled for transmission during each time slot. The procedure for this is to take the next data block in sequence, and move it to the empty space. So for this example, the first block in TS1, blk0, is moved to TS0. The next block in TS1, blk1, is also moved up. Then, since TS0 still has an empty data block space, blk3 from TS1 is also moved up. TS0 then has all of its spaces filled, and now looks like:

TS0=>blk0, blk0, blk1, blk3

Now TS1 and most of TS2 are empty, so the data blocks from TS3 get moved up. Once this sequence is finished, the matrix looks like:

TS0=>blk0, blk0, blk1, blk3

TS1=>blk0, blk2, blk0, blk1

TS2=>blk3, blk4, blk0, blk4

TS3=>blk0, blk1, blk2, blk5

TS4=>

TS5=>

This is also shown graphically in FIG. 6. Empty and incomplete time slots, such as TS4 and TS5 in this example, get filled up simply by repeating the original sequence, while still filling up the idle time. Hence the first six time slots would appear as:

TS0=>blk0, blk0, blk1, blk3

TS1=>blk0, blk2, blk0, blk1

TS2=>blk3, blk4, blk0, blk4

TS3=>blk0, blk1, blk2, blk5

TS4=>blk0, blk0, blk1, blk3

TS5=>blk0, blk2, blk0, blk1

The next two time slots in this sequence, TS6 and TS7, would have the same data blocks as TS2 and TS3. Therefore what is actually produced by this process in a new, shorter scheduling matrix, now only four time slots long. FIG. 7 graphically depicts this new repeating matrix created by filling up idle time.

It is obvious from the example given above that as long as the original order is followed, a user can now receive the data file ahead of time in contrast with the on time delivery of the original scheduling matrix. A user may even enter the system mid-time slot and begin using the data as soon as a starting block, blk0, is received.

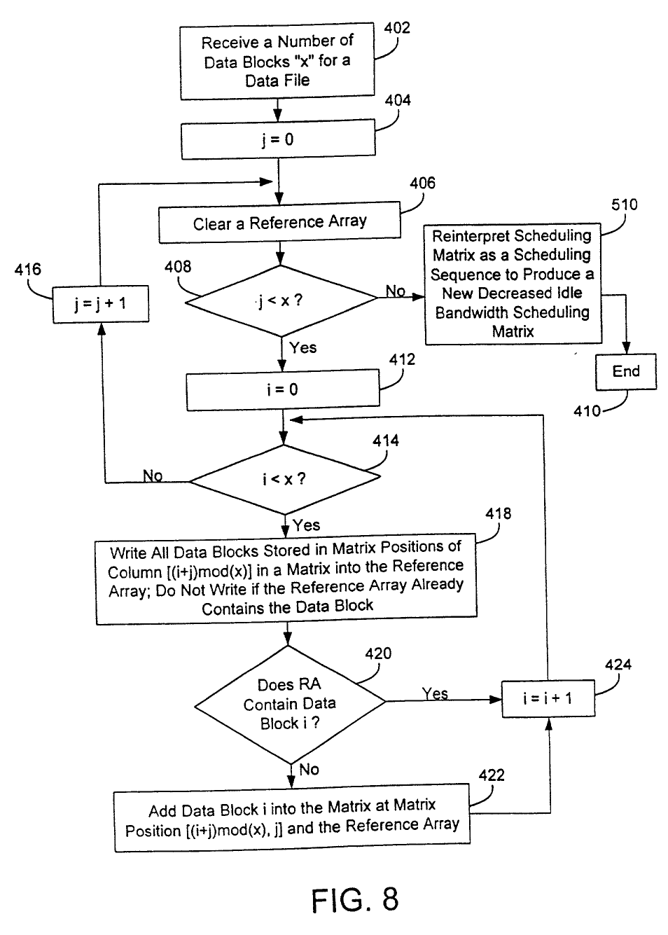

In this fashion, time slots become largely a computational fiction, as the data blocks become a continuous stream, and at any point in the stream a user may jump onto the system and begin receiving data. As can be seen in FIG. 8, this additional step is a relatively simple step 510, performed at what was the end of the procedure 410.

For simplicity's sake, the above description of FIGS. 4-10 dealt with an instance where the selected bandwidth was set to a constant equal to an integer number of data blocks. However, the constant bandwidth need not be equal to an integer number of data blocks. Instead, what is simply required is that the delivery sequence adhere to the sequence developed as in FIG. 8. The data stream generated by the delivery sequence developed in FIG. 8 is then provided to a lower level hardware device (e.g., a network card or the channel server) which controls broadcast of the digital data. Rather than broadcasting an integer number of data blocks, the lower level hardware device will transmit as much data as possible within the bandwidth allocated to the file.

As will be appreciated by those of skill in the art, at the abstraction level of the delivery sequence, one need not worry about the actual transmission of data. Instead, the delivery matrix provides the sequence and the lower level hardware device controls broadcast of data utilizing the allocated bandwidth. Hence an allocated bandwidth which includes a fraction of a data block size can be fully utilized. Once the allocated bandwidth has been utilized, the lower level device will pause broadcast of this particular data file until bandwidth is again available.

In the above example, the maximum bandwidth used in the original scheduling matrix is used in the decreased idle time matrix. This is so that, no matter at what point a user begins receiving data, the maximum wait time has not changed. However, as will be apparent to one of ordinary skill in the art, bandwidth may be adjusted to either the cost or benefit of time. It is important that for a data-on-demand service that the maximum time taken does not exceed the time it takes to execute the file. If this were to happen, the result would be a scheduling matrix with a total number of time slots greater than the number of time slots the original scheduling matrix contained. If this were a two hour movie, for example, it might take three hours to play, leaving gaps in the middle of the movie. Some applications, however, might be able to use or even desire this function, such as streams of data that can be downloaded without being used immediately.

Single streams of data which have a constant, fully optimized, bandwidth can simply be combined together. The result would be a multiple stream bandwidth, whose total width is the sum of the single streams.

As shown, decreasing the idle time is very useful for calculating a scheduling matrix for a single stream of data. In this manner, an assigned amount of bandwidth may be fully used when transmitting a stream of data. As mentioned above, however, an aspect of the invention is creating a three dimensional delivery matrix. With a three dimensional delivery matrix, a decreased idle time delivery matrix may also be calculated and implemented in exactly the same fashion. However, once the use of the decreased idle time delivery matrix is used on a single stream, and then multiple, fully optimized, single streams are combined together, this will likely outperform the three dimensional matrix system in most circumstances.

So what is embodied is a computer implemented method for transmission of an on-demand data file comprising an act of preparing a delivery matrix defining a repeating data transmission sequence suitable for broadcast over a medium to a plurality of clients in a non-specific manner. This act of preparing the delivery matrix further comprises reducing a data file into data blocks having at least a first block, and ordering the data blocks into a said repeating data transmission sequence. Therefore a user may receive the repeating data transmission sequence and begin using the data file in an uninterrupted manner as soon as the first block is received. This repeating data transmission sequence requires a pre-determined bandwidth, and further there is de-minimus idle time in transmission of the repeating data transmission sequence. Also transmission of the data on-demand file requires an amount of transmission bandwidth that is independent of the number of clients.

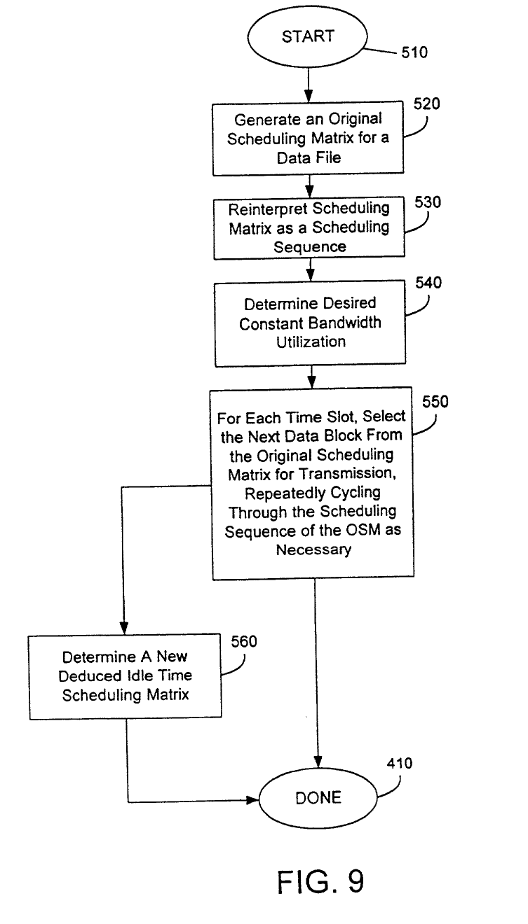

FIG. 9 summarizes in flow chart form how a decreased idle time scheduling sequence is determined. First 520 an original scheduling matrix is generated for a data file. This original scheduling matrix is simply a non-decreased idle time scheduling matrix in accordance with the present invention. It is referred to as “original” for clarity purposes. What becomes apparent about the original scheduling matrix is not the structured matrix itself, but the order in which the data blocks are derived. The order of the data blocks in the original matrix is therefore of primary importance in determining a decreased idle time scheduling matrix. The original matrix is therefore treated as a scheduling sequence 530. As shown above, this scheduling sequence can be used to fill in the idle time in the original matrix. However, at this point it might be desirable to first adjust the amount of bandwidth assigned to the data file 540. Once the bandwidth is assigned, data block are move “up” the matrix until all of the idle time slots are removed. Intellectually, if this is thought of as a sequence, the idle time slots are deleted 550. Once this is completed, the sequence from the original scheduling matrix is repeated. What will end up happening is that there will be a new repeating sequence, and this can be thought of as a new decreased idle time scheduling matrix 560.

It is worth noting that the difference between a scheduling sequence and decreased idle time scheduling matrix is mainly cognitive. One can be depicted as a linear sequence and the other as a repeating matrix, but the net result is that a user receives a constant stream of non client specific blocks of data.

A method for further reducing the bandwidth necessary for broadcasting scheduling matrices of DOD data blocks is to broadcast frequently occurring data blocks on a dedicated channel. As can be seen from the exemplary matrices below selected data blocks occur more frequently than other data blocks within the stream. The original delivery matrix with idle time appeared as follows:

TS0=>blk0, <-->, <-->, <-->

TS1=>blk0, blk1, blk3, <-->

TS2=>blk0, blk2, <-->, <-->

TS3=>blk0, blk1, blk3, blk4

TS4=>blk0, blk4, <-->,<-->

TS5=>blk0, blk1, blk2, blk5

The delivery matrix with decreased idle time created by the process of FIG. 9 appears as follows:

TS0=>blk0, blk0, blk1, blk3

TS1=>blk0, blk2, blk0, blk1

TS2=>blk3, blk4, blk0, blk4

TS3=>blk0, blk1, blk2, blk5

The exemplary decreased idle time matrix represented as a linear repeating stream of data would appear as the following:

stream0=>blk0, blk0, blk1, blk3, blk0, blk2, blk0, blk1, blk3, blk4, blk0, blk4, blk0, blk1, blk2, blk5

As can be seen from a linear representation of the exemplary delivery matrix, blk0 is transmitted more frequently than blocks 1-5. Different delivery matrices may result in a different data blocks occurring more or less frequently within a given stream of data blocks. In any delivery matrix data blocks occurring earlier in the sequence will occur more frequently, with block 0 always occurring most frequently.

Because blk0 occurs in the data stream more frequently than other data blocks, a narrower transmission bandwidth can be achieved by sending blk0 and other frequently occurring blocks in an independent data stream. This stream could have a greatly decreased bandwidth over the original stream, and the bandwidth assigned to the original stream could also be decreased by transmitting only the less frequent data blocks. For example, if the above stream were broken into two separate streams, a prefetch stream carrying only data blk0 and a primary stream carrying the remaining data blocks, the two repeating streams would appear as follows:

primary stream=>blk1, blk3, blk2, blk1, blk3, blk4, blk4, blk1, blk2, blk5

prefetch stream=>blk0

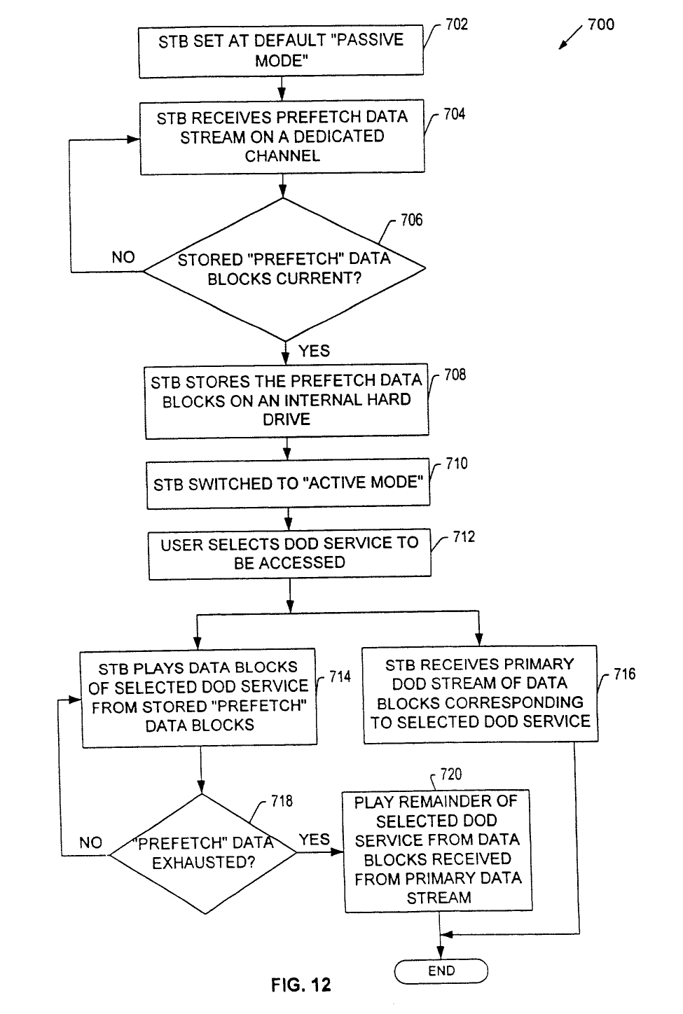

Thus by transmitting blk0 in an independent data stream, the bandwidth required to transmit the primary data stream is reduced by 37.5%. This reduction is due to Blk0 comprising 6 of 16 total data blocks in the primary data stream, such that removal of Blk0 effectively reduces the number of data blocks transmitted in the primary data stream by 6. The additional bandwidth required to transmit the prefetch data stream containing Blk0 is small in comparison, being dependent on the amount of buffering performed by a receiving STB. This buffering will be discussed in more detail with respect to FIG. 12 below.

A significant advantage to this method of transmission is decreased time required to access a selected data-on-demand service. As soon as blk0 of a selected DOD service is received a user may begin using the selected service, whereas without the prefetch stream a user would have to wait until blk0 occurred in the primary data stream. Because blk0 is transmitted continuously over an independent stream, a service may be used without waiting for the next blk0 to be received from a stream containing many different data blocks. Of course, in order to have fluid use of the data-on-demand system, blk1 has to be received and ready for use by the time blk0 is finished, this requires that the primary data stream has a large enough bandwidth to assure that blk1 is received before blk0 has concluded.

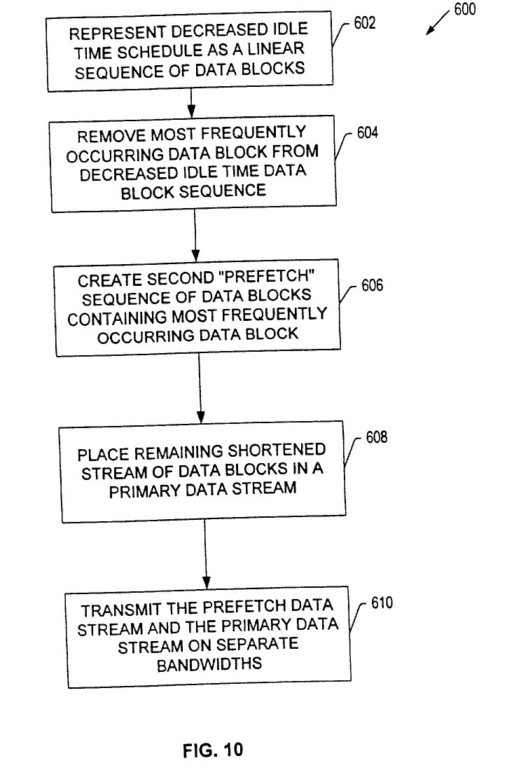

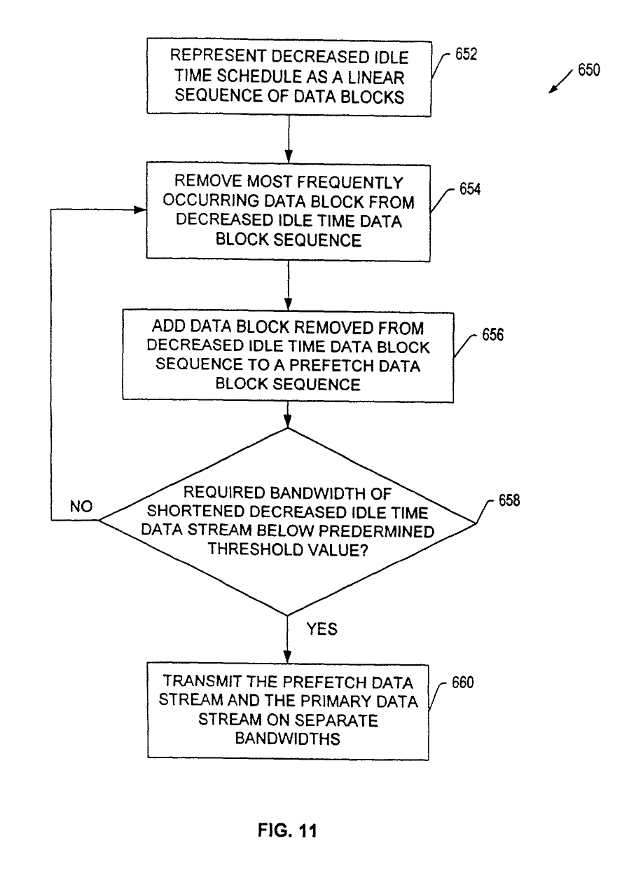

FIG. 10 illustrates a process at 600 for scheduling DOD data blocks for transmission on a primary data stream and a prefetch data stream in accordance with one embodiment of the present invention. At a first step 602 a decreased idle time schedule is represented as a linear sequence of data blocks arranged in the order the data blocks would be transmitted. At a step 604, the most frequently occurring data block is removed from the sequence leaving a shorter sequence of data blocks requiring a much narrower bandwidth. As discussed above, Blk0 always occurs most frequently. At a step 606 the data block removed from the decreased idle time sequence is placed in a prefetch data stream comprised entirely of Blk0 data blocks. Then in a step 608 the shortened sequence of data blocks is placed in a primary data stream. Then in a step 610 the primary data stream and the prefetch data stream are transmitted as two separate repeating data streams on separate bandwidths to receiving set-top-boxes via the transmission medium 110 (FIG. 1B).

FIG. 11 illustrates a process at 650 for scheduling DOD data blocks for transmission on a primary data stream and a prefetch data stream in accordance with one embodiment, wherein multiple DOD data blocks from a DOD delivery matrix are transmitted on a prefetch data stream thereby minimizing the total necessary transmission bandwidth. At a first step 652 a decreased idle time schedule is represented as a linear sequence of data blocks arranged in the order the data blocks would be transmitted. At a step 654, the most frequently occurring data block is removed from the sequence leaving a shorter primary sequence of data blocks requiring a much narrower bandwidth. At a step 656 the data block removed from the decreased idle time sequence is placed in a prefetch data stream.

In step 658 a determination is made as to whether the bandwidth required transmit the shorter primary stream of data blocks has been reduced below a predetermined threshold value. This step may require many complex subprocesses that would be apparent to one skilled in the art. If the bandwidth requried for the primary data stream is below the threshold, then the process continues to step 660. At step 660 the primary data stream and the prefetch data stream are transmitted as two separate repeating data streams on separate bandwidths to receiving set-top-boxes via the transmission medium 110 (FIG. 1B).

If the required bandwidth is above the threshold value then the process returns to step 654, wherein the data block occurring with the greatest frequency of the remaining data blocks is removed. Then in step 656 the removed data block is added to the prefetch data stream. The process continues to repeat itself until the required transmission bandwidth is determined to be below the threshold value in step 658, at which time the process concludes at step 660. In alternative embodiments other criteria may be used instead of a threshold value, such as minimizing the combined bandwidth requirement for both the primary and prefetch data streams. In this manner the bandwidth required to transmit DOD services is further reduced over the decreased idle time and constant bandwidth delivery method of Khoi Hoang's parent application entitled DECREASED IDLE TIME AND CONSTANT BANDWIDTH DATA-ON-DEMAND BROADCAST DELIVERY MATRICES, filed Jun. 25, 2001, bearing U.S. patent application Ser. No. 09/892,017.

Removing frequently occurring data blocks from the primary data stream has the effect of greatly reducing the total number of data blocks contained in the primary data stream, thereby reducing the bandwidth required for transmitting the primary data stream. The table below describes the sample bandwidth savings for the removal of selected data blocks from the primary data stream:

TABLE 1
Bandwidth savings for particular pre-loading data blocks in a six block
sequence:

| | | |
|---|---|---|
| | Estimated | |
| | Frequency of | |
| | Occurrence in data | |
| DATA BLOCK | block (in a 6 block | Estimated |
| (PRELOADED) | sequence) | Bandwidth savings |

| | | | |
|---|---|---|---|
| Blk 0 | 100% | 1 | BW |
| Blk 1 | ˜50% | ˜.5 | BW |
| Blk 2 | ˜33% | ˜.33 | BW |
| Blk 3 | ˜25% | ˜.25 | BW |
| Blk 4 | ˜20% | ˜.20 | BW |
| Blk 5 | ˜16% | ˜.16 | BW |

In order to have immediate access to a DOD service transmitted by the above method, a receiving STB must pre-load and store some or all of the data contained in the prefetch data stream. Because the STB must first load and store a blk0 of any DOD service it is to display, there is a tradeoff between the transmission bandwidth saved and an accessing delay time. By pre-loading the prefetch data stream and storing the prefetch data blocks a client STB may access a selected DOD service with minimal delay. This requires a receiving STB to have a memory sufficient to store the data contained in the prefetch data stream.

FIG. 12 illustrates a set-top-box pre-loading process at 700 in accordance with one embodiment of the present invention. In step 702, the set top box is set to an idle or passive mode. Typically this mode would be a default mode for all client set-top-boxes. In step 704, the set-top-box receives the prefetch data stream on a dedicated channel. In an exemplary embodiment the prefetch data stream is received on the electronic programming guide channel. In step 706 the set top box determines whether the prefetch data blocks received are more recent than prefetch data that had been stored earlier. An identifier contained within each prefetch data block indicates to the set top box how recent a data block is. If the data blocks received are more recent the set top box stores the latest prefetch data blocks in an internal memory 308 (FIG. 3) in step 708, typically a hard disk drive magnetic storage device. Typically earlier data blocks are overwritten with more recent prefetch data blocks, though older versions may be retained for various reasons.

In step 710 the set top box is switched to active mode either by a timer, or by user command. In an exemplary embodiment the set top box automatically switches to active mode whenever any user command is received by the set top box. In such an embodiment the set top box would remain in the active mode for some time period, after which it would return to a passive mode.

In step 712 the set top box receives a command to play a selected DOD service. This may be accomplished by a user entering a code corresponding to the selected DOD service or by selecting the DOD service from a menu within the electronic program guide service. In step 714 the set top box plays the first data block (blk0) of the selected DOD service from the prefetch data blocks stored in step 708. In step 716 the set top box tunes into the appropriate channel and receives and stores in memory 308 (FIG. 3) the primary data stream corresponding to the selected DOD service. In an exemplary embodiment this step occurs in parallel with step 714 until the user stops playing the selected DOD service.

In step 718, if all prefetch data blocks corresponding to the selected DOD service have been played the process continues to step 720. In step 720 the remainder of the DOD service is played from the primary stream data blocks previously received in step 716. This allows the first data block (blk0), or the first few data blocks of a DOD service to be played from the stored prefetch data blocks while the primary stream of data blocks corresponding to the selected DOD service are downloaded from a server. Such a system allows seamless viewing of DOD services with minimal delay in access time and reduced bandwidth requirements. For optimal function, sufficient prefetch data blocks must be stored and played to allow data blocks from the primary data stream to download in time for use. This could require increases in either the bandwidth of the prefetch stream or in the primary data stream.

The data configured into the prefetch data stream and eventually loaded into the idle set top box through the prefetch stream may change over the course of the day, week, or month to reflect preferences of users and create a maximum of bandwidth savings. For example, on a Monday night in the autumn, a particular sporting event may be made more prevalent in the prefetch data stream as opposed to a weekend night, when the newest family feature movie released has the beginning sequence sent in the prefetch data stream.

The set top box user can start the desired programming at any time without delay because of the preloaded data block sequence already stored on the STB while the box was in idle mode. This pre-fetch data block sequence can be continually updated while the STB is idle mode to reflect pre-programmed changes made by the user (such as an order for a movie that the user has not started watching) or by a preset sequence update based on anticipated DOD user requests.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

[image]

[image]

[image]

[image]

[image]

[image]

[image]

[image]

[image]

[image]

[image]

What is claimed is:

1. A computer implemented universal broadcast method comprising the act of preparing a delivery matrix defining a data transmission sequence suitable for broadcast, to a plurality of clients, on-demand data in a non client specific manner, wherein transmission of said on-demand data files comprises a first stream including a first subset of said data transmission sequence and a second stream comprising a second subset of said data transmission sequence.

2. The computer implemented method as recited in claim 1, wherein said first subset and said second subset do not include any common data blocks.

3. The computer implemented method as recited in claim 2, wherein said first subset comprises an optimized set of data blocks, wherein said second subset is the remainder of said data transmission sequence, whereby said optimized set of data blocks is dependent on the frequency of data block distribution.

4. The computer implemented method as recited in claim 1, wherein said first stream further includes a prefetch stream identifier.

5. The computer implemented method as recited in claim 4, wherein said prefetch stream identifier signals a universal set top box to pre-load said first stream in to electronic storage onto said universal set-top-box.

6. The computer implemented method as recited in claim 4, wherein said universal set top box may load said first stream, while said universal set top box is idle.

7. The computer implemented method as recited in claim 1, wherein said first subset includes a minimum amount of data blocks needed to begin a program, whereby said minimum amount is dependent on available bandwidth.

8. The computer implemented method as recited in claim 1, wherein the ratio of said transmission sequence allocated between said first subset and said second subset is optimally configured based on the amount of transmission bandwidth available.

9. The broadcast method as recited in claim 1, whereby transmission of said on-demand data files requires an amount of transmission bandwidth that is independent of the number of said plurality of clients.

10. A computer implemented method as recited in claim 9, wherein the act of generating a delivery matrix comprises the acts of:
preparing a first scheduling matrix suitable for transmission of a first data file, said first data file being represented by a first plurality of data blocks, said first scheduling matrix providing a first sequence for transmitting said first plurality data blocks sequentially within time slots in a manner such that any client receiving transmission of said first data file according to said first scheduling matrix may begin accessing said first data file within one time slot.

11. A computer implemented method as recited in claim 10 wherein said first scheduling matrix is a constant bandwidth scheduling matrix.

12. A computer implemented method as recited in claim 10 wherein said first scheduling matrix is a variable bandwidth scheduling matrix.

13. A computer implemented method as recited in claim 11 wherein a constant quantity of data from said first plurality of data blocks are scheduled for transmission during allocated bandwidth.

14. A computer implemented method as recited in claim 13 wherein control of transmission during allocated bandwidth is performed by a low level hardware device.

15. The computer implemented broadcast method a recited in claim 1, whereby said first stream is a pre-fetch stream, said pre-fetch stream accessed by a universal set top box during a set of pre-fetch receiving scenarios.

16. The computer implemented method as recited in claim 15, wherein said set of pre-fetch receiving scenarios include the activation of a pre-loading command onto said set top box by a user.

17. The computer implemented method as recited in claim 15, wherein said set of pre-fetch receiving scenarios include a pre-ordered program from the user.

18. A computer implemented method for generating a constant bandwidth, decreased idle time scheduling matrix suitable for the delivery of on-demand data in a non client specific format, said method comprising the acts of:
generating a scheduling matrix suitable for transmission of a first data file, said first data file being represented by a first plurality of data blocks, said first scheduling matrix providing a first sequence for transmitting said first plurality data blocks sequentially within time slots in a manner such that any client receiving transmission of said first data file according to said first scheduling matrix may begin accessing said first data file within one time slot;
determining a desired constant transmission bandwidth, wherein said constant bandwidth is then used to stream said data blocks sequentially according to the order of said first scheduling matrix;
determining a correct allocation for dividing streaming data blocks into separate streams based on said constant bandwidth; and
loading at least one of said separate streams onto a set top box, while set top box is not transmitting to a display device.

19. A universal set top box which performs the following functions:
a. switching to an idle mode;
b. accessing a pre-loading transmission stream at some time while in said idle mode;
c. storing a set of data blocks in said pre-loading transmission stream on a computer readable medium; and
d. retrieving a portion of said data blocks upon switching from said idle mode to an active mode and signaled by a user and displaying a first portion first program from said stored pre-loaded transmission stream;
e. automatically tuning into a correct data stream, such that there is no interruption in broadcast between said first portion of said program and the remainder of said first program;
whereby said retrieval step allows said user to access a program immediately without further access to broadcast data.

20. The set top box as recited in claim 19, capable of performing the additional function of periodically updating said prefetch stream while in said idle mode.

21. The set top box as reciting in claim 20, wherein said periodically updating step is dependent on a user instruction.

22. The set top box as recited in claim 20, wherein said periodically updating step is based on Video on Demand preferences.

23. The set top box as recited in claim 20, wherein said periodically updating step is based on user history.

24. The set top box as recited in claim 19, wherein said step of switching to an idle mode is performed under a set of idle mode scenarios.

25. The set top box as recited in claim 24, wherein said idle mode scenario, includes user inactivity.

26. A computer implemented method for pre-loading a set top box with broadcast data, which includes the acts of:
switching said STB to a idle mode;
automatically tuning said STB to said a first channel in order to select data for preprogramming said STB, said first channel including a pre-fetch data stream;
processing said first plurality of data blocks as received when said user switches said STB to an active mode, said processing including at least one of the following:
decoding said received data blocks;
decompressing said received data blocks;
re-assembling said received data blocks as necessary; and
storing said received data blocks to a local memory present within said STB; and
providing said first data file to an output device by said user of said universal STB.

27. The computer implemented method as recited in claim 26 wherein said output device is a television.

28. The computer implemented method as recited in claim 26 wherein said output device is a display monitor.

29. The computer implemented method as recited in claim 26 wherein said output device is a video cassette recorder (VCR).

30. The computer implemented method as recited in claim 26 wherein said output device is a computer system.

31. The computer implemented method as recited in claim 18, wherein said correct allocation is based on available bandwidth.

32. A data delivery matrix comprising
a data file divided into a number of data blocks;
said number of data blocks being arranged into an order determined by the steps of:
a) dividing said data file into said number of data blocks;
b) setting a first variable to zero;
c) clearing a reference array;
d) comparing said first variable to the total number of said number of data blocks;
e) if said first variable is less than the total number of said number of data blocks, set a second variable to zero;
f) compare said second variable to the total number of said number of data blocks;
g) if said second variable is less than the total number of said number of data blocks writing one or more stored data blocks stored in a column of a scheduling matrix into said reference array, said column determined by the [(i+j)mod(x)] where i is said second variable, j is said first variable and x is said number of data blocks;
h) if said reference array already has at least one of said stored data blocks, do not write a second copy;
i) check if said reference array contains a block corresponding to said second variable;
j) if said reference array does not contain said data block corresponding to said second variable, said data block is added to said reference array and said scheduling matrix at a position in said matrix equal to [(i+j)mod(x),j] and said second variable is increased by 1;
k) if said reference array does contain said data block corresponding to said second variable, said second variable is increased by 1;
l) repeat steps g) through k) until said second variable is equal to said total number of data blocks;
m) increase said first variable by 1;
n) repeat steps c) through m) until said first variable is equal to said total number of data blocks; and
o) reconfigure said scheduling matrix into a plurality of streams;
wherein said order is transmitted in a repeating signal over a medium having a bandwidth assigned to said data file, and wherein said bandwidth is fully used by said repeating signal.

33. The data delivery matrix of claim 32, wherein said step of reconfiguring said scheduling matrix into a plurality of streams involves determining the size of said bandwidth assigned to said data file and determining the optimal size of a first delivery stream, whereby first delivery stream includes a beginning sequence of said data file.

34. The data delivery matrix of claim 33, wherein determining the size of said bandwidth assigned to said file minimizes said bandwidth.

35. The data delivery matrix of claim 33, wherein determining the size of said bandwidth assigned to said file maximizes said bandwidth.

36. The data delivery system as recited in claim 32, wherein said plurality of data delivery streams derived from a data delivery matrix comprises a plurality of distinct data files.

37. A computer implemented universal data broadcast method comprising the acts of:
at a universal data broadcast system, performing the acts of:
preparing a delivery matrix defining a data transmission sequence suitable for broadcast, to a plurality of clients, on-demand data in a non client specific manner, wherein transmission of said on-demand data comprises a first stream including a first subset of said data transmission sequence and a second stream comprising a second subset of said data transmission sequence; wherein said first stream is pre-loading transmission data;
providing a first channel server suitable for the transmission of said pre-loading transmission data via a first channel;
prior to data broadcast, preparing a second channel server for the transmission of an electronic program guide, said electronic program guide (EPG) including information on a third channel contains at least said second stream; and
transmitting data from said first channel and said second channel; and
at a universal STB, performing the acts of:
receiving digital data in said first stream in said first channel while said universal STB is in a passive mode;
storing said digital data in said first stream in a computer readable medium while said universal STB is in said passive mode;
receiving digital data said EPG;
providing said EPG data to a user of said universal STB;
receiving data processing instructions from said user of said universal STB; and
implementing said instructions from said user of said universal STB.

38. A computer implemented method as recited in claim 37, wherein the act of generating a deliver matrix comprises the acts of:
preparing a first scheduling matrix suitable for transmission of a first data file, said first data file being represented by a first plurality of data blocks, said first scheduling matrix providing a first sequence for transmitting said first plurality data blocks sequentially within time slots in a manner such that any client receiving transmission of said first data file according to said first scheduling matrix may begin accessing said first data file within a set number of time slots, wherein said set number is based on the number of blocks in said pre-loading stream,
wherein said first data file does not include any common data blocks included in said pre-loading stream.

39. The method as recited in claim 38, further comprised of the act of prior to data broadcast, preparing a third channel server for the transmission of data-on-demand information, said preparing said third channel server including the acts retrieving said delivery matrix into a memory of said third channel server and retrieving data blocks contained within said second stream scheduled for delivery by said delivery matrix into said memory of said third channel server; and
transmitting data from said third channel.

40. A computer implemented method as recited in claim 39 wherein said first scheduling matrix is a constant bandwidth scheduling matrix.

41. A computer implemented method as recited in claim 40 wherein a constant number of said first plurality of data blocks are scheduled for transmission during each time slot.

42. A computer implemented method as recited in claim 40 wherein said first scheduling matrix is a variable bandwidth scheduling matrix.

43. A data-on-demand (DOD) broadcast server method for providing DOD services suitable for broadcast to a plurality of clients, in a non-client specific manner, via a transmission medium, comprising the acts of:
providing a first data stream including a plurality of first data blocks and a plurality of additional data blocks, said first data blocks and said additional data blocks comprising a selected DOD service;
removing said plurality of first data blocks from said first data stream;
placing at least one of said first data blocks in a second data stream; and
transmitting said second data stream via said transmission medium; and
transmitting said first data stream via said transmission medium, such that a user receiving said first and second data streams may combine at least a portion of said first and second data streams in order to access said selected DOD service.

44. The data-on-demand (DOD) broadcast server method of claim 43, wherein said first and second data streams are configured to be received by a set-topbox.

45. The data-on-demand (DOD) broadcast server method of claim 43, wherein said additional data blocks include a plurality of second data blocks and a plurality of third data blocks.

46. The DOD broadcast server method of claim 45, further comprising the acts of:
removing said plurality of second data blocks from said first data stream;
placing at least one of said second data blocks in said second data stream; and
wherein a user receiving said first and second data streams may combine at least a portion of said first, second and third data blocks in order to access said selected DOD service.

47. The DOD broadcast server method of claim 45, wherein accessing said selected DOD service includes viewing a video representation of at least a portion of said DOD service.

48. A data-on-demand (DOD) broadcast reception method for accessing DOD services transmitted from a non client specific DOD broadcast server system via a DOD receiver, comprising the acts of:
receiving a first data stream comprising a portion of a selected DOD service via a transmission medium; and
receiving a second data stream comprising a portion of said selected DOD service via said transmission medium; and
combining said first and second data streams in order to access said selected DOD service.

49. The DOD broadcast reception method of claim 48, further comprising:
preloading at least a portion of said second data stream in a memory location;
combining at least a portion of said preloaded data stream with at least a portion of said first data stream in order to play at least a portion of said DOD service.

50. The DOD broadcast reception method of claim 48, further comprising receiving an electronic programming guide (EPG), said EPG enabling said DOD receiver to select a DOD service to be accessed.

51. A data-on-demand (DOD) broadcast server method for providing DOD services suitable for broadcast to a plurality of clients, in a non-client specific manner, via a transmission medium, comprising the acts of:
providing a decreased idle time linear sequence of data blocks containing data including a selected DOD service;
removing a most frequently occurring data block from said decreased idle time sequence of data blocks;
placing said removed most frequently occurring data block in a prefetch data stream such that said prefetch data stream includes prefetch data blocks corresponding to said selected DOD service;
transmitting said prefetch data stream via said transmission medium; and
transmitting said remaining decreased idle time sequence of data blocks via said transmission medium such that a receiving device may combine said remaining decreased idle time sequence of data blocks and said prefetch data blocks to create said selected DOD service, thereby decreasing the bandwidth necessary to transmit said DOD service.

52. The DOD broadcast server method of claim 51, wherein said prefetch data stream includes an electronic program guide (EPG), said EPG including information indicative of what services are available from said DOD broadcast server.

53. The DOD broadcast server method of claim 52, wherein said EPG enables a user to select said selected DOD service for viewing.

54. The DOD broadcast server method of claim 51, further comprising:
removing a plurality of additional data blocks from said decreased idle time sequence of data blocks;
placing at least one of said plurality of additional data blocks in said prefetch data stream such that said prefetch data stream includes said most frequently occuring data blocks and said additional data blocks corresponding to said selected DOD service; and
transmitting said remaining decreased idle time sequence of data blocks via said transmission medium such that a receiving device may combine said remaining decreased idle time sequence of data blocks, and said prefetch data blocks to create said selected DOD service, thereby further decreasing the bandwidth necessary to transmit said DOD service.

55. The DOD broadcast server method of claim 54, wherein said plurality of additional data blocks include a plurality of a second most frequently occurring data block, thereby further decreasing the bandwidth necessary to transmit said DOD service.

56. The DOD broadcast server method of claim 55, wherein said plurality of additional data blocks include a plurality of a third most frequently occurring data block, thereby further decreasing the bandwidth necessary to transmit said DOD service.

57. The DOD broadcast server method of claim 56, wherein said plurality of additional data blocks include a plurality of a fourth most frequently occurring data block, thereby further decreasing the bandwidth necessary to transmit said DOD service.

58. The DOD broadcast server method of claim 57, wherein said plurality of additional data blocks include a plurality of a fifth most frequently occurring data block, thereby further decreasing the bandwidth necessary to transmit said DOD service.

59. The DOD broadcast server method of claim 54, further comprising transmitting an electronic program guide (EPG), said EPG including data indicating DOD services transmitted by said DOD broadcast server and selectable by a user.

60. A data-on-demand (DOD) broadcast reception method for accessing DOD services transmitted from a non client specific DOD broadcast server system via a DOD receiver, comprising the acts of:
receiving a prefetch data stream containing prefetch data blocks corresponding to a selected DOD service;
storing said prefetch data blocks in a memory location;
receiving a primary data stream containing primary data blocks corresponding to said selected DOD service; and
processing said primary data blocks and said prefetch data bocks in order to enable a user to access said selected DOD service.

61. The data-on-demand (DOD) broadcast reception method of claim 60, further including receiving an electronic program guide (EPG) including information indicating available DOD services.

62. The data-on-demand (DOD) broadcast reception method of claim 60, further comprising:
receiving user input indicative of said selected DOD service;
switching to a channel corresponding to said selected DOD service in response to said user input; and
receiving said primary data stream from said channel corresponding to said selected DOD service.

63. The data-on-demand (DOD) broadcast reception method of claim 62, including receiving an electronic program guide (EPG).

64. The data-on-demand (DOD) broadcast reception method of claim 63, wherein said electronic guide provides information to a user indicative of DOD services available from said DOD broadcast server.

65. The data-on-demand (DOD) broadcast reception method of claim 64, wherein said user may view a selected DOD service by selecting information received from said EPG corresponding to said selected DOD service.

66. The data-on-demand (DOD) broadcast reception method of claim 60, further comprising displaying said DOD service via a video display device.

67. A universal set-top-box (STB) capable of receiving and handling a plurality of digital services such as VOD and digital broadcast, wherein at least one of said digital services is transmitted as a plurality of independent data streams, said universal STB comprising:
a databus;
a first communication device suitable for coupling to a digital broadcast communications medium, said first communication device operable to receive digital data including a primary data stream and a prefetch data stream;
memory bi-directionally coupled to said databus;
a digital data decoder bi-directionally coupled to said databus; and
a central processing unit (CPU) bi-directionally coupled to said databus, said CPU implementing a STB control process controlling said memory, said digital decoder, and said demodulator, said STB control process operable to process digital data received at said first communications device, said CPU being further operative to process said primary data stream and said prefetch data stream.

68. A universal STB as recited in claim 67, wherein said prefetch data stream is stored in said memory.

69. A universal STB as recited in claim 67, wherein said databus is a high speed databus suitable for performing data communications in a real time manner as required to accomplish real time processing of said digital data received at said first communications device.

70. A universal STB as recited in claim 67, wherein said databus is a USB databus.

71. A universal STB as recited in claim 67, wherein said databus is a firewire databus.

72. A universal STB as recited in claim 67, wherein said memory includes a mass storage device.

73. A universal STB as recited in claim 72 wherein said mass storage device is a hard disk.

74. A universal STB as recited in claim 67 wherein said memory includes high speed buffer memory.

75. A universal STB as recited in claim 74 wherein said high speed buffer memory is random access memory (RAM).

76. A universal STB as recited in claim 67 wherein said digital data decoder has video and audio decoding capabilities.

77. A universal STB as recited in claim 67, wherein said digital data decoder is an MPEG decoder.

78. A universal STB as recited in claim 67 wherein said digital data decoder supports a variety of digital data commands including play, stop, pause, step, rewind, and forward.

79. A universal STB as recited in claim 67 wherein said first communication device includes a demodulator.

80. A universal STB as recited in claim 67 wherein said demodulator is a QAM demodulator.

81. A universal STB as recited in claim 67 wherein said first communication device is a cable modem.

82. A universal STB as recited in claim 67 wherein said CPU implements a user interface driver suitable for interpreting commands received from a user interface coupled to said databus.

83. A universal STB as recited in claim 82, wherein said user interface includes a remote control device.

84. A universal STB as recited in claim 82, wherein said user interface includes a keyboard.

85. A universal STB as recited in claim 82, wherein said user interface includes a computer system.

86. A universal STB as recited in claim 67, wherein said STB control process is capable of determining the nature of data received in a plurality of channels via information provided in an electronic program guide.

87. A universal STB as recited in claim 86, wherein said STB control process is operable to simultaneously tune into two or more of said plurality of channels, and to simultaneously process data from two or more of said plurality of channels.

88. A universal STB as recited in claim 87, wherein said STB control process is operable to provide EPG data to a user of said universal STB.

89. A universal STB as recited in claim 88, wherein said STB control process is operable to receive and implement instructions from said user of said universal STB.

90. A universal STB as recited in claim 89, wherein said STB control process is operable to tune said STB to a first channel in order to select data requested by said user, determine the nature of said selected data, decode said selected data, decompress said selected data, re-assemble said decoded data, store said selected data to said memory, and provide said selected data in a properly processed manner to an output device.
